(19) United States
(12) Patent Application Publication
(10) Pub. No.: US 2026/0106642 A1
(43) Pub. Date: Apr. 16, 2026

(54) PROGRAMMABLE INDUCTOR FOR TIME DIVISION DUPLEXING RADIO TRANSCEIVER

(71) Applicant: Realtek Semiconductor Corp., Hsinchu (TW)

(72) Inventor: Chia-Liang (Leon) Lin, Fremont, CA (US)

(21) Appl. No.: 18/915,726

(22) Filed: Oct. 15, 2024

(51) Int. Cl. H04B 1/40; H04L 5/14

(52) U.S. Cl. CPC H04B 1/40; H04L 5/14

(57) ABSTRACT

A TDD (time-division duplexing) radio transceiver includes: a PA (power amplifier) that processes a first signal and delivers a second signal at a first node in accordance with a transmitter-enabling signal; an LNA (low-noise amplifier) that processes a third signal at a second node and delivers a fourth signal in accordance with a receiver-enabling signal; a first switch configured to shunt the second node to ground in accordance with the transmitter-enabling signal; an antenna attached to the first node; and a programmable inductor featuring a first inductor inserted between the first node and the second node, a second inductor that is inserted between the second node and a third node and strongly coupled to the first inductor, and a programmable capacitor used to shunt the third node to ground in accordance with the transmitter enabling signal.

### BACKGROUND OF THE INVENTION

### Field of the Invention

The present invention generally relates to time division duplexing radio transceiver, and more particularly to those using a programmable inductor for transmitter-receiver co-matching.

### Description of Related Art

FIG. 1 illustrates a TDD (time-division duplexing) radio transceiver 100 featuring PA (power amplifier) 110, LNA (low-noise amplifier) 120, co-matching network 130, and antenna 140. Radio transceiver 100 is in a transmitter mode when a transmitter-enabling signal ENTX is 1 and in a receiver mode when a receiver-enabling signal ENRX is 1, whereas ENTX and ENRX cannot be both 1 at the same time. When ENTX is 1, PA 110 processes a TX input signal from a preceding circuit and through co-matching network 130 converts into an antenna signal to be transmitted by antenna 140. When ENRX is 1, LNA 120 processes a signal received from antenna 140 via co-matching network 130 and delivers an RX output signal to a subsequent circuit. The co-matching network 130 facilitates the sharing of the same antenna between PA 110 and LNA 120, which reduces but does not completely remove the loading effects of LNA 120 on PA 110.

What is disclosed is a co-matching network using a programmable inductor to alleviate the loading effect of LNA on PA in the transmitter mode without comprising the performance of LNA in the receiver mode.

### BRIEF SUMMARY OF THIS INVENTION

An objective of this invention is to establish a co-matching network for a TDD (time-division duplexing) radio transceiver containing both a transmitter and receiver, reducing the receiver's loading effect on the transmitter and enhancing the transmitter's performance by utilizing a programmable inductor.

A TDD (time-division duplexing) radio transceiver includes: a PA (power amplifier) that processes a first signal and delivers a second signal at a first node in accordance with a transmitter-enabling signal; an LNA (low-noise amplifier) that processes a third signal at a second node and delivers a fourth signal in accordance with a receiver-enabling signal; a switch configured to shunt the second node to ground in accordance with the transmitter-enabling signal; an antenna attached to the first node; and a programmable inductor featuring a first inductor inserted between the first node and the second node, a second inductor that is inserted between the second node and a third node and strongly coupled to the first inductor, and a programmable capacitor inserted between the third node and ground and of a capacitance depending on the transmitter enabling signal.

### BRIEF DESCRIPTION OF THE DRAWINGS

FIG. 1 presents a schematic of a functional block diagram of a TDD (time-division duplexing) radio transceiver.

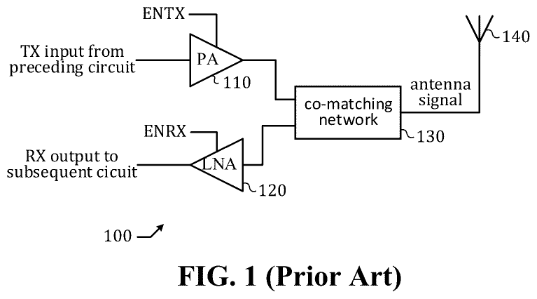

FIG. 2A presents a schematic of a schematic diagram of a TDD (time-division duplexing) radio transceiver in accordance with an embodiment of the present invention.

FIG. 2B shows a schematic diagram of a programmable capacitor that can be used in the TDD radio transceiver of FIG. 2A.

FIG. 3 depicts a top view of an exemplary layout of two strongly coupled inductors of the programmable inductor of the TDD radio transceiver of FIG. 2A.

FIG. 4 depicts a power amplifier that can be used in the radio transceiver of FIG. 2A.

FIG. 5 depicts a low-noise amplifier that can be used in the radio transceiver of FIG. 2A.

### DETAILED DESCRIPTION OF THIS INVENTION

The present invention relates to radio transceivers. While the specification describes several example embodiments of the invention considered favorable modes of practicing the invention, it should be understood that the invention can be implemented in many ways and is not limited to the particular examples described below or to the particular manner in which any features of such examples are implemented. In other instances, well-known details are not shown or described to avoid obscuring aspects of the invention.

Persons of ordinary skill in the art understand terms and basic concepts related to microelectronics that are used in this disclosure, such as “voltage,” “current,” “signal,” “frequency,” “differential signal,” “capacitor,” “inductor,” “resistor,” “transistor,” “MOST (metal-oxide semiconductor field-effect transistor),” “PMOST (p-channel metal oxide semiconductor field-effect transistor),” “NMOST (n-channel metal oxide semiconductor field-effect transistor),” “AC (alternating current),” “DC (direct current),” “source,” “gate,” “drain,” “node,” “ground node,” “power supply node,” “cascode,” “amplifier,” “common-source,” “common-gate,” “reactance,” and “impedance.” For brevity, in this present disclosure, “field effect transistor” is simply referred to as “transistor.” Individuals with ordinary skill in the field can identify symbols for an inductor, capacitor, switch, AND gate, NMOS transistor, and PMOS transistor, and can identify “source,” “gate,” and “drain” of MOS transistor, for both NMOS and PMOS. Terms and basic concepts like these are apparent to those of ordinary skill in the art and thus will not be explained in detail here. Those of ordinary skill in the field are able to interpret schematics and understand the interconnections between circuit elements with no need for elaborate explanations.

A signal is either a voltage or current of a variable level that carries certain information and can vary with time. The level of the signal at a moment represents the state of the signal at that moment. A signal is a “voltage signal” (“current signal”) if it is a voltage (current). In this present disclosure, since “voltage signals” appear more often than “current signals,” for brevity a “signal” refers to a “voltage signal” unless it is otherwise specified as a “current signal.”

In this document, the abbreviation “DC” refers to direct current, while “AC” denotes alternating current. Any signal may be broken down into a DC part, which is essentially constant, and an AC part, which is largely characterized by its fluctuation.

A DC node is a node of a substantially fixed electric potential. In particular, “V_{DD}” denotes a special DC node referred to as a power node. A ground node is a special DC node of zero voltage (OV). For brevity, a ground node is simply referred to as ground. Depending on the context, sometimes “ground” refers to “AC ground” of a substantially fixed electrical potential that is not necessarily equal to OV.

A logical signal has two states: low (0) and high (1). When “Q is high” or “Q is low” is stated, it means Q is in its respective 1 or 0 state. A logical signal can be used to either turn on or turn off a function; the state that leads to the turn-on of the function is referred to as the “on state,” while the state that leads to the turn-off function is referred to as the “off state.”

A switch operates based on a logical signal, acting as a short circuit when the signal is in the on state and an open circuit when it is in the off state.

By way of example but not limitations, in this present disclosure, “high (1)” state and “low (0)” state correspond to “on” state and “off” state, respectively.

A MOST (metal-oxide semiconductor field-effect transistor) is an active device with source, gate, and drain terminals that can act as an amplifier. There are NMOST (n-channel) and PMOST (p-channel) transistors. A MOST operates in the “saturation region” and can act effectively as an amplifier when the gate-to-source voltage exceeds a certain threshold voltage, but the gate-to-drain voltage is lower than the threshold. It functions as a switch in the “triode region” when both voltages are higher than the threshold.

A MOST can be configured as a common-source amplifier that converts an input voltage received from its gate into an output current delivered via its drain, while its source is usually connected to a sufficiently low-impedance node so that a voltage at its source can remain approximately fixed regardless of a dynamic nature of the input voltage.

A MOST can also be configured as a common-gate amplifier that receives an input current from its source and delivers an output current via its drain, while its gate is usually connected to a sufficiently low-impedance node so that a voltage at its gate can remain approximately fixed regardless of a dynamic nature of the input current. A common-gate amplifier can effectively relay the input (source) current into the output (drain) current.

In a “cascode” configuration, one MOST is stacked upon another, combining common-source and common-gate amplifiers and forming a “cascode amplifier.” This setup ensures good reverse isolation, minimizing the impact of drain load changes on the first MOST.

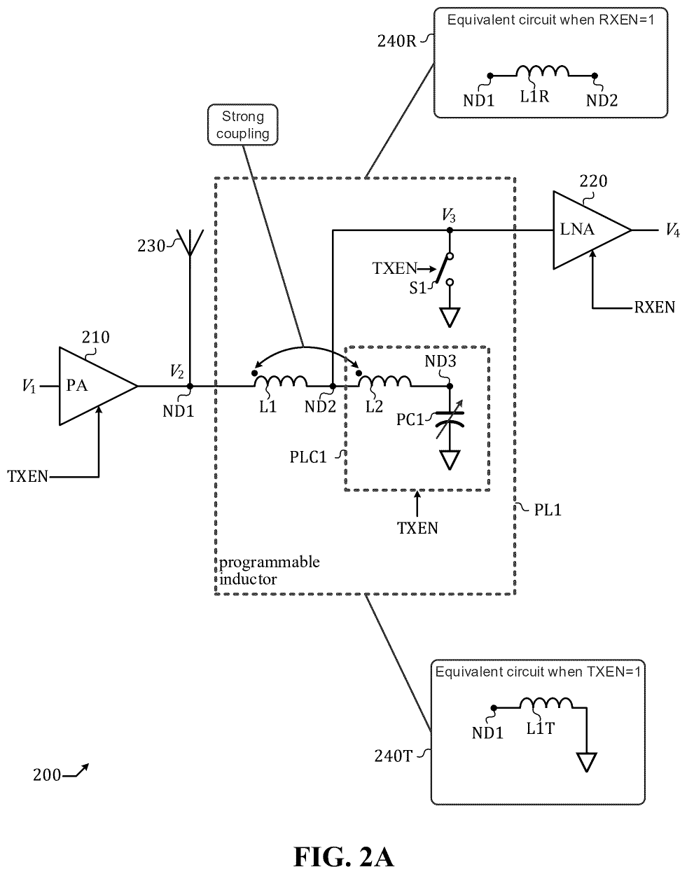

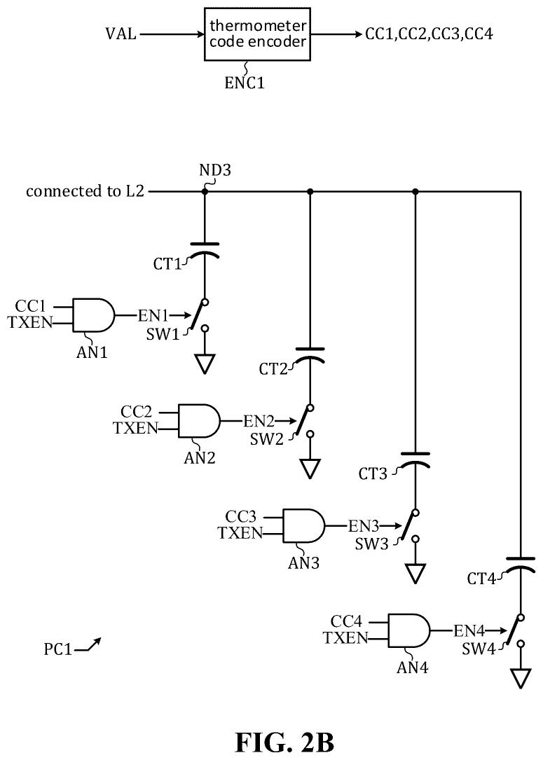

A schematic diagram of a TDD radio transceiver 200 in accordance with an embodiment of the present invention is shown in FIG. 2A. TDD radio transceiver 200 includes: a PA (power amplifier) 210 that amplifies a first signal V₁ into a second signal V₂ at a first node ND1 in accordance with a transmitter-enabling (TXEN) signal; an LNA (low-noise amplifier) 220 that amplifies a third signal V₃ at a second node ND2 into a fourth signal V₄ in accordance with a receiver-enabling (RXEN) signal; an antenna 230 attached to the first node ND1; and a programmable inductor PL1 comprising a first inductor L1 inserted between ND1 and ND2, a first switch S1 controlled by TXEN and configured to short ND2 to ground when TXEN is 1, and a programmable LC (which stands for inductor-capacitor) network PLC1 that is controlled by TXEN and inserted between ND2 and ground and comprises a serial connection of a second inductor L2, which is inserted between ND2 and a third node ND3, and a programmable capacitor PC1 inserted between ND3 and ground and controlled by TXEN.

Radio transceiver 200 is in a transmitter mode when TXEN is 1, and in a receiver mode when RXEN is 1, wherein TXEN and RXEN cannot be both 1 at the same time.

When RXEN is 1, TXEN must be 0 and PA 210 is turned off to reduce a loading effect to the first node ND1, both S1 and the programmable LC network PLC1 become open circuits effectively, while V₂ is established by antenna 230 and coupled to V₃ via L1 that serves impedance matching purpose. In this case, the programmable inductor PL1 is equivalent to a serial inductor LIR inserted between ND1 and ND2, as shown inside the callout box 240R, wherein LIR and L1 have approximately the same inductance.

When TXEN is 1, RXEN must be 0 and PA 210 is turned on to amplify V₁ into V₂ that is established at ND1 and radiated by antenna 230 to the air. In the meanwhile, ND2 is shorted to ground via S1 to prevent a potentially large swing of V₂ from damaging LNA 220 through L1, while L1 is effectively shunted to ground with an enlarged inductance. The loading effect the programmable inductor PL1 to PA 210 is thus reduced. In this case, the programmable inductor PL1 is equivalent to a shunt inductor LIT that is inserted between ND1 and ground, as shown inside the callout box 240T, wherein LIT has larger inductance than L1.

The programmability, which causes PL1 to behave as two different equivalent circuits, the shunt inductor LIT and the serial inductor LIR, in accordance with TXEN, is based on a strong coupling between L1 and L2, and programmability of PC1.

A schematic diagram of an exemplary embodiment of programmable capacitor PC1 is shown in FIG. 2B. By way of example but not limitation, programmable capacitor PC1 is controlled by TXEN along with a control word VAL of four possible values 1, 2, 3, and 4. Programmable capacitor PC1 includes a thermometer code encoder ENC1 that encodes VAL into four logical signals CC1, CC2, CC3, and CC4 in accordance with the following table:

| VAL | CC1 | CC2 | CC3 | CC4 |
|---|---|---|---|---|
| 1 | 1 | 0 | 0 | 0 |
| 2 | 0 | 1 | 0 | 0 |
| 3 | 0 | 0 | 1 | 0 |
| 4 | 0 | 0 | 0 | 1 |

Programmable capacitor PC1 further includes four capacitors CT1, CT2, CT3, and CT4, four switches SW1, SW2, SW3, and SW4, and four AND gates AN1, AN2, AN3, and AN4. AND gate AN1 (AN2, AN3, AN4) receives TXEN and CC1 (CC2, CC3, CC4) and outputs a logical signal EN1 (EN2, EN3, EN4) that is 1 when both TXEN and CC1 (CC2, CC3, CC4) are 1 and otherwise 0. CT1 (CT2, CT3, CT4) connects to L2 at ND3 on one end and to ground on the other end through switch SW1 (SW2, SW3, SW4), which is controlled by EN1 (EN2, EN3, EN4).

When RXEN is 1 and consequently TXEN must be 0, all of EN1, EN2, EN3, and EN4 are 0, all of SW1, SW2, SW3, and SW4 are turned off, all of CT1, CT2, CT3, and CT4 are effectively floating and thus disabled, and consequently programmable capacitor PC1 is floating and behaves like an open circuit. In this case, programmable LC network PLC1 is effectively an open circuit, so is switch S1, and therefore the programmable inductor PL1 is degenerated into the equivalent serial inductor LIR inserted between ND1 and ND2, as shown in the callout box 240R, where LIR has approximately the same inductance as that of L1.

When TXEN is 1 and VAL is 1 (2, 3, 4), among the four switches SW1, SW2, SW3, and SW4, only SW1 (SW2, SW3, SW4) is turned on, and programmable capacitor PC1 is degenerated into a single capacitor CT1 (CT2, CT3, CT4) that connects to L2 at ND3 on one end and to ground on the other end. The control word VAL and the capacitances of CT1, CT2, CT3, and CT4 are chosen such that the programmable capacitor PC1 can resonate with L2 at the frequency of the first signal V₁, causing the programmable LC network PLC1 to behave like a short circuit, and therefore ND2 is effectively shorted to ground via both S1 and the programmable LC network PLC1. As a result, the programmable inductor is degenerated into L1 inserted between ND1 and ground. However, due to the resonance between L2 and PC1, there is a strong current flowing through L2. The strong coupling between L1 and L2 effectively increases the magnetic flux linkage of L1. Therefore, the inductance of L1 is effectively enlarged, and can be modeled by the shunt inductance LIT shown in callout box 240T, where LIT has larger inductance than L1.

In summary, the programmable inductor PL1 is equivalent to a serial inductor when TXEN is 0, but equivalent to a shunt inductor of a larger inductance than the serial inductor when TXEN is 1. By using the programmable inductor PL1, L1 becomes a shunt inductor of an enlarged inductance, and thus a loading effect to the PA 210 is effectively reduced in the transmitter mode.

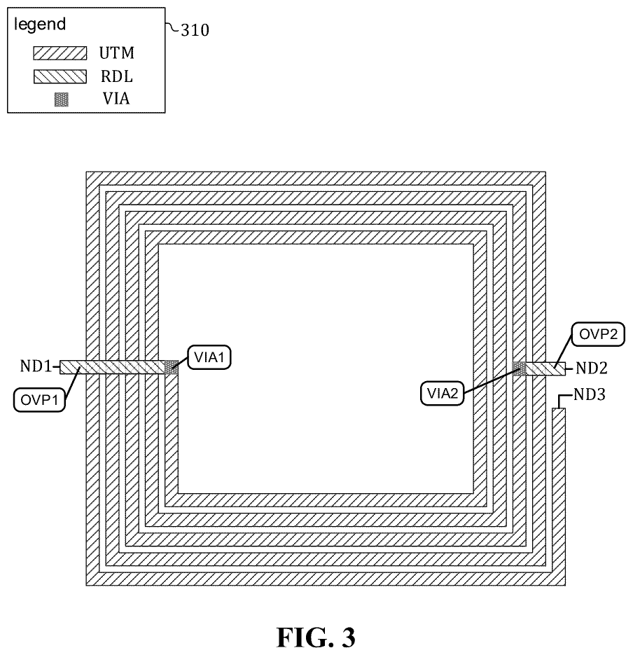

By way of example but not limitation, TDD radio transceiver 200 is fabricated on a silicon substrate using CMOS (complementary metal-oxide semiconductor) process technology, featuring a multi-layer structure with active device layers and several metal layers, including a UTM (ultra-thick metal) layer, a RDL (re-distribution layer), and a few lower metal layers. A top view of an exemplary layout of L1 and L2 are shown in FIG. 3. A legend is shown in box 310. Note that “VIA” is a layer sandwiched between UTM and RDL and used for inter-metal connection for two metals laid out on UTM and RDL, respectively. L1 and L2 are laid out in parallel closely in a concentric manner. L1 is laid out on UTM in a spiral topology using a first metal trace spiraling outward in a counterclockwise direction from VIA1 to VIA2. VIA1 is connected to ND1 through a first overpass trace OVP1 laid out on RDL, while VIA2 is connected to ND2 through a second overpass trace OVP2 laid out on RDL. L2 is laid out on UTM in a spiral topology using a second metal trace spiraling outward in the counterclockwise direction from VIA2 to ND3. The first metal trace and the second metal are parallel to one another and spiral in a concentric manner to establish strong coupling.

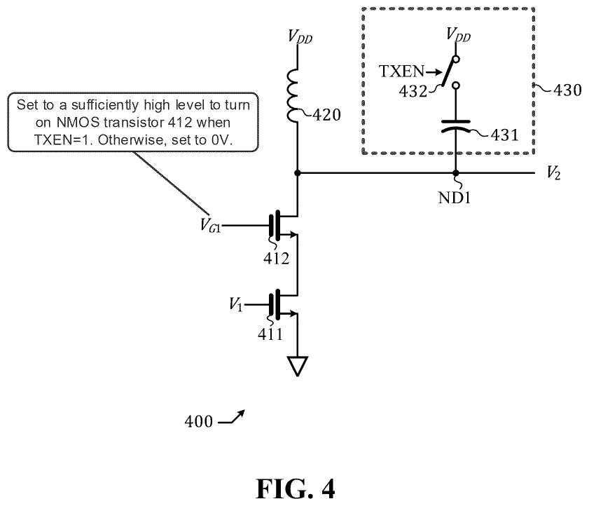

FIG. 4 shows a cascode amplifier 400 that can be used to embody PA 210 of FIG. 2. Cascode amplifier 400 includes: NMOS transistors 411 and 412 configured as a cascode amplifier to amplify V₁ into V₂; a load inductor 420; and a programmable capacitor 430 comprising a serial connection of a load capacitor 431 and a switch 432 controlled by TXEN. When TXEN is 1, load capacitor 431 is effectively enabled to resonate with load inductor 420 to present a high impedance to boost a gain for cascode amplifier 400. NMOS transistor 412 is configured as a common-gate amplifier controlled by a first gate bias voltage V_{G1}, which is set to a sufficiently high level to turn on NMOS transistor 412 when TXEN is 1 and otherwise set to OV to turn it off. Circuit topology wise, cascode amplifier 400 is well known in the prior art and thus not explained in detail here.

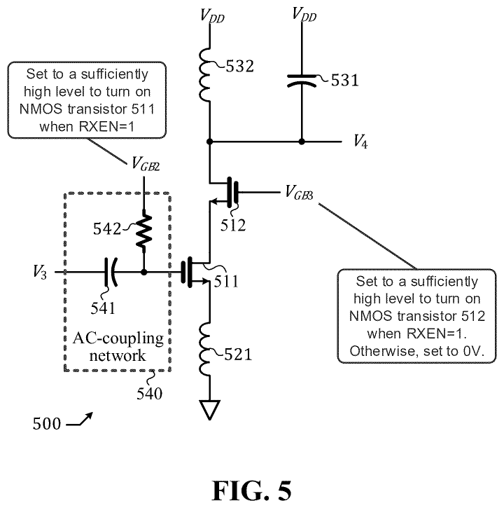

A LNA 500 that can be used to embody LNA 220 of FIG. 2 is shown in FIG. 5. LNA 500 comprises two NMOS transistors 511 and 512, a source-degenerating inductor 521, a load inductor 532, and a load capacitor 531. NMOS transistor 512 is configured as a common-gate amplifier and controlled by a third gate bias voltage V_{GB3}, which is set to a sufficiently high level to turn on NMOS transistor 512 when RXEN is 1 and otherwise set to OV to turn it off. NMOS transistors 511 and 512 are stacked up to form a cascode amplifier to amplify V₃ into V₄, while source-degenerating inductor 521 provides inductive source degeneration. Load inductor 532 and load capacitor 531 form a resonant network to present a high impedance to boost a gain of LNA 500. LNA 500 further includes an AC coupling network 540 comprising an AC coupling capacitor 541 and a DC coupling resistor 542, so that NMOS transistor 511, which is configured and a common-source amplifier, can receive an input signal of an AC voltage approximately equal to the AC voltage of V₃ and of a DC voltage equal to a second gate bias voltage V_{GB2}, which must be set to a sufficiently high level to turn on NMOS transistor 511 and preferably bias it into the saturation region when RXEN is 1. Circuit topology wise, LNA 500 is well known in the prior art and thus not explained in detail here.

In certain embodiments an additional transistor can be added to the transistor stack-up topology to enhance reverse isolation or to reduce stress on neighboring transistors, besides what is described in the present disclosure.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A TDD (time-division duplexing) radio transceiver includes:
a PA (power amplifier) that processes a first signal and delivers a second signal at a first node in accordance with a transmitter-enabling signal;
an LNA (low-noise amplifier) that processes a third signal at a second node and delivers a fourth signal in accordance with a receiver-enabling signal;
a first switch configured to shunt the second node to ground in accordance with the transmitter-enabling signal;
an antenna attached to the first node; and
a programmable inductor featuring a first inductor inserted between the first node and the second node, a second inductor that is inserted between the second node and a third node and strongly coupled to the first inductor, and a programmable capacitor inserted between the third node and ground and of a capacitance depending on the transmitter enabling signal.

2. The TDD radio transceiver of claim 1, wherein the first inductor and the second inductor are laid out closely in parallel in spiral topology, and in a concentrical manner.

3. The TDD radio transceiver of claim 2, wherein the first inductor includes a first metal trace spiraling from the first node to the second node, the second inductor includes a second metal trace spiraling from the second node to the third node of the same direction of spiraling as that of the first inductor.

4. The TDD radio transceiver of claim 1, wherein the PA includes a cascode amplifier comprising a stacking of a second transistor upon a first transistor, and a load inductor.

5. The TDD radio transceiver of claim 4, wherein the second transistor is configured as a common-gate amplifier controlled by a first gate bias voltage that is set to a first level to turn on the second transistor when the transmitter-enabling signal is asserted, and otherwise set to a second level to turn off the second transistor.

6. The TDD radio transceiver of claim 5, wherein the PA further comprises a switch-capacitor network placed in parallel with the load inductor and comprising a serial connection of load capacitor and a second switch controlled by the transmitter-enabling signal.

7. The TDD radio transceiver of claim 1, wherein the LNA comprises a cascode amplifier comprising a stacking of a second transistor upon a first transistor, a degenerating inductor for providing source generation for the cascode amplifier, and a parallel connection of a load inductor and a load capacitor for serving as a load of the cascode amplifier.

8. The TDD radio transceiver of claim 7, wherein the second transistor is configured as a common-gate amplifier and controlled by a third gate bias voltage that is set to a first level to turn on the second transistor when the receiver-enabling signal is asserted, and otherwise set to a second level to turn off the second transistor.

9. The TDD radio transceiver of claim 8, wherein the LNA further comprises an AC (alternate current) coupling network comprising an AC coupling capacitor configured to couple the third signal into a gate signal at a gate of the first transistor and a DC (direct current) coupling resistor configured to couple a second gate bias voltage to the gate of the first transistor, which is configured as a common-source amplifier.

10. The TDD radio transceiver of claim 1, wherein the programmable capacitor is approximately an open circuit when the transmitter-enabling signal is in an off state.

11. The TDD radio transceiver of claim 10, wherein the programmable capacitor resonates with the second inductor when the transmitter-enabling signal is in an on state.

12. The TDD radio transceiver of claim 1, wherein the programmable capacitor comprises: an encoder configured to encode an integer control word into a plurality of logical signals that are gated with the transmitter-enabling signal to generate a plurality of switch-enabling signals; a parallel connection of a plurality of switch-capacitor networks controlled by the plurality of switch-enabling signals, respectively.
